(19) United States
(12) Patent Application Publication
(10) Pub. No.: US 2006/0066742 A1
(43) Pub. Date: Mar. 30, 2006

(54) Photography device and photography method thereof

(75) Inventor: Akira Miyata, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/232,738

(22) Filed: Sep. 22, 2005

(30) Foreign Application Priority Data
Sep. 24, 2004 (JP) 2004-277213

(51) Int. Cl. H04N 5/222

(52) U.S. Cl. 348/333.01

(57) ABSTRACT

Commence video recording processing (Step S3), the CPU 9 judges whether or not a menu display is to be performed (Step S4) and when judged a menu display is to be performed, a menu is displayed as a recording image in the image display section 10. Then, the CPU judges whether or not a setup change of an imaging condition has been performed (Step S6). At this stage, according to the menu displayed in the image display section 10, the user by manipulating the key input section 15 can change the setup of an imaging condition. When a keystroke operation command is performed by the user to setup an imaging condition, the CPU judges that an imaging condition has been setup.••Then, when the CPU judges that a setup of an imaging condition has been changed, the setup of an imaging condition will be changed (Step S9).

### CROSS-REFERENCE TO RELATED APPLICATION

This application is based upon and claims the benefit of priority from the prior Japanese Patent Application No. 2004-277213, filed Sep. 24, 2004, the entire contents of which is incorporated herein by reference.

### BACKGROUND OF THE INVENTION

1. Field of the Invention

The present invention relates to a photography device and accompanying photography method having a video recording feature which can be used for a digital camera.

2. Description of the Related Art

In recent years, digital cameras have been emerging which can perform video recording due to technological advances.

Additionally, a user can record desired still image photography and video recordings by a setup of imaging conditions, such as white balance, etc. to perform still image photography and video recording.

Further, in conventional prior art, an invention of a digital camera has been disclosed in Japanese Laid-Open (Kokai) Patent Application No. 2000-270251 titled “DIGITAL CAMERA.” In particular, the described digital camera can change the image quality without interrupting recording by providing an input section for inputting commands to change the image quality during a video recording and a function for changing the compression ratio of images based on a command from the input section during a video recording.

### SUMMARY OF THE INVENTION

The present invention has been made in view of the above-mentioned conventional problems. Accordingly, an object of the present invention is to provide a photography device and accompanying photography method which can easily change different various item fields in the setup of imaging conditions during video recording while maintaining a light weight and miniaturized construction.

In order to achieve the above-mentioned object, there is provided a photography device, comprising an image pickup section for imaging an imaged object and outputting video data; a recording control section for recording video data outputted from the image pickup section to a recording section; a menu display control section for displaying in a display section a menu screen to change setup of the photography device during a recording operation by the recording control section of video data to the recording section; and a setup change section for changing setup of the photography device is changed by a user according to the menu screen displayed in the display section by the menu display control section.

Also, in order to achieve the above-mentioned object, there is provided a photography device, comprising an image pickup section for imaging an imaged object and outputting video data; a setup section for setup an imaging condition for video recording by a user; a recording control section for recording video data outputted from the image pickup section to a recording section; and the recording control section records setup information based on an imaging condition for video recording set by the setup section to the recording section, while recording video data outputted from the image pickup section.

Also, in order to achieve the above-mentioned object, there is provided a photography device, comprising an image pickup section for imaging an imaged object and outputting video data;

a setup section for setup of an imaging condition for video recording by a user; a recording control section for recording video data outputted from the image pickup section to a recording section; and the recording control section records video data that does not reflect an imaging condition for video recording set by the setup section to the recording section, while recording video data that does reflect an imaging condition for video recording set by the setup section to the recording section.

Also, in order to achieve the above-mentioned object, there is provided a photography device, comprising an image pickup section for imaging an imaged object and outputting video data; a recording control section for recording video data outputted from the image pickup section to a recording section; a setup section for setup of an imaging condition for video recording by a user regardless of whether or not while recording video data to the recording section by the recording control section; and the recording control section records video data outputted from the image pickup section to the recording section at least based on current imaging condition for video recording set by the setup section.

Also, in order to achieve the above-mentioned object, there is provided a photography method for a photography device, comprising the steps of imaging an imaged object and outputting video data; recording video data on a recording medium; displaying in a display section a menu screen to change setup of the photography device during a recording operation by the step for recording of video data to the recording medium; and changing setup of the photography device by a user according to the menu screen displayed in the display section.

Also, in order to achieve the above-mentioned object, there is provided a program documentation medium for storing a recording control program executed by a processor in a photography device, comprising the steps of imaging an imaged object and outputting video data; recording video data on a recording medium; displaying in a display section a menu screen to change setup of the photography device during a recording operation by the step for recording of video data to the recording medium; and changing setup of the photography device by a user according to the menu screen displayed on the display section.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram of the digital camera of an embodiment of the present invention;

FIG. 2 is a flow chart showing operation of the digital camera of an embodiment of the present invention;

FIG. 3 is a flow chart showing operation of the digital camera of an embodiment of the present invention;

FIGS. 4A-4B are diagrams showing the appearance of the screen displayed in an image display section 10 before menu display and after menu display;

FIGS. 5A-5B are diagrams showing the appearance of an image displayed in the image display section 10 when switched to a state where white balance can be changed;

FIGS. 6A-6B are diagrams showing the appearance of an image displayed in the image display section 10 when switched to a state where EV (exposure correction) can be changed;

FIGS. 7A-7B are diagrams showing the appearance of an image displayed in the image display section 10 when switched to a state where sharpness and filter can be changed;

FIGS. 8A-8B are diagrams showing the appearance of video data recorded in a flash memory 11 in an embodiment of the present invention and modified example three;

FIG. 9 is a diagram showing the appearance of video data recorded in the flash memory 11 of the modified example three; and

FIG. 10 is a diagram showing the appearance of video data recorded to the flash memory 11 of modified example three.

### DETAILED DESCRIPTION OF THE PREFERRED EMBODIMENTS

Hereinafter, the preferred embodiments of the present invention will be described in detail with reference to the drawings.

### Embodiment of the Present Invention

A. Digital Camera Configuration

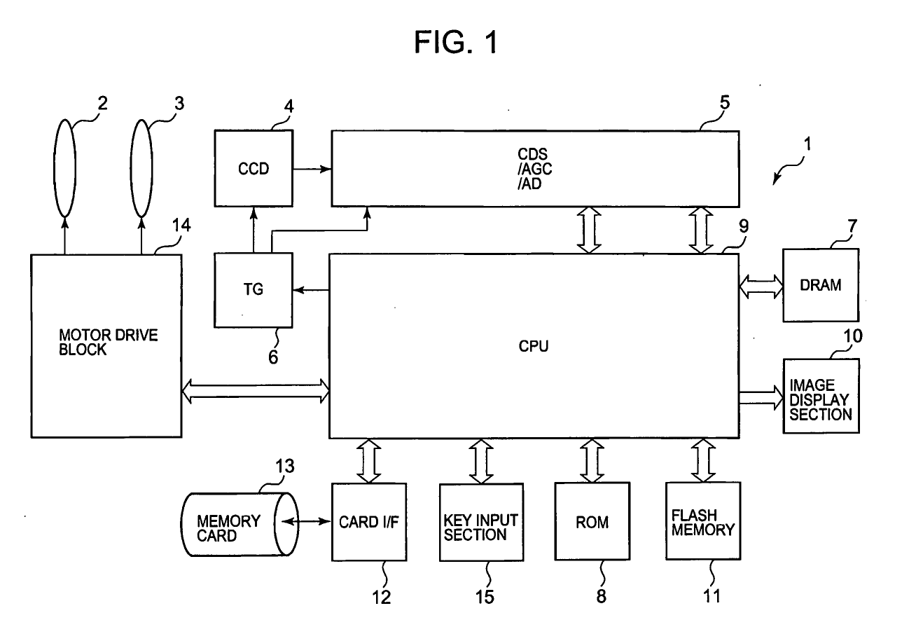

FIG. 1 is a block diagram showing the electrical outline configuration of a digital camera 1 which actualizes the photography device of the present invention.

The digital camera 1 comprises a focus lens 2, a zoom lens 3, a CCD 4, a unit circuit 5, a TG 6 (Timing Generator), a DRAM 7, a ROM 8, a CPU 9, an image display section 10, a flash memory 11, a card interface 12, a motor drive block 14 and a key input section 15.••In the card interface 12, a memory card 13 can be connected that is easily removably attachable to the camera main body card slot (omitted from diagram). The focus lens 2 and the zoom lens 3 configurations from the lens group are not shown separately. The motor drive block 14 constitutes the focus lens 2 and the zoom lens 3 which are driven in an optical axis direction by a focus motor and a zoom motor; and a driver which drives the focus motor and the zoom motor according to a control signal from the CPU 9, respectively.

The CCD 4 (image pickup section) performs photoelectric conversion for the light of an imaged object projected via the focus lens 2 and the zoom lens 3 and outputs to the unit circuit 5 as an imaging signal. Also, the CCD 4 is driven with a timing signal of a predetermined frequency generated by the TG 6. The unit circuit 5 is connected to the TG 6. The unit circuit 5 is constituted by a CDS (Correlated Double Sampling) circuit which performs and retains a correlation double sampling of an imaging signal outputted from the CCD 4, a gain adjustment amplifier (AGC) then amplifies the same imaging signal and an AD converter (AD) converts the imaging signal after amplification into a digital signal. The output signal of the CCD 4 is forwarded to the CPU 9 as a digital signal through the unit circuit 5.

The CPU 9 is a one chip microcomputer which controls each section of the digital camera 1 while having the functions of performing image processing of video data (pixel interpolation processing, gamma(γ)correction processing, generation of a luminosity color difference signal, white balance processing, etc.), compression-expansion of video data, etc. (for example, compression-expansion of JPEG, MPEG formats).

The image display section 10, including a color LCD and its driver circuit, displays photographed object images which have been imaged by the CCD 4 as through images when the digital camera 1 has been placed in a photography standby state. Recorded images (still images/videos) are readout and expanded from the flash memory 11 used for storage or the memory card 13 during playback of these recorded images and then displayed. The image display section 10 is equivalent to the display section of the present invention.

The key input section 15 outputs a manipulation signal corresponding to a user's keystroke operation to the CPU 9 that includes a plurality of operation keys, for example, a mode key, a shutter button key, a menu screen key, a “SET” key, a cursor key (↑, ↓, ←, →) and a cancel key. This key input section 15 is equivalent to the menu display instruction section, the setup change section and the selection section of the present invention.

The DRAM 7 is used as a buffer memory for video data temporary storage of digitized imaged objects after being imaged by the CCD 4, as well as a working memory for the CPU 9. The program required for controlling each section of the digital camera 1 (the motor drive block 14, the image display section 10, etc.) by the CPU 9 and the data required for controlling each section are archived in the ROM 8. The CPU 9 functions as a photography device of the present invention according to the above-mentioned program.

The flash memory 11 and the memory card 13 are recording medium (recording section) for saving recorded video data, etc. In the embodiment, although recorded video data is archived (saved) in the flash memory 11, video data, etc. can also be recorded in the memory card 13 by operation of the user's key input section 15.

B. Digital Camera Functions

Hereinafter, the function of each configuration constituting the characteristics of the digital camera 1 in the preferred embodiment will be explained.

Notably, the below described video recording processing is synonymous with various related terminology such as moving images, motion images, digital recording, MPEG, JPEG, AVI files, etc.). Furthermore, collective references to “imaging conditions” can be variously expressed as recording conditions, video recording conditions, camera setup conditions, photography conditions, etc. Also, an “imaging condition” is a single photography setup item field among a number of “imaging conditions.”)

When a manipulation signal corresponding to the video recording mode setup has been sent by operation of the mode key from the user's key input section 15, the CPU 9 applies image processing (pixel interpolation processing, white balance processing, etc.) to the video data of the imaged object processed by the CCD 4 and stores the data in the buffer memory (DRAM 7). Subsequently, what is called a through image display for displaying this stored video data in the image display section 10 is performed.

Also, when the CPU 9 judges that a manipulation signal has been sent corresponding to a depression of the shutter button from the key input section 15, video recording processing commences.

The video recording processing compresses the video data stored in the buffer memory, which is followed by processing for archiving in the flash memory 11 (recording control section). At this stage, the images (recorded images) photographed by the image video recording processing are displayed in the image display section 10 (image display control section)

When video recording processing commences, the CPU 9 judges whether or not a manipulation signal corresponding to the menu screen key has been sent from the key input section 15. When determined as having been sent, a menu display (current imaging conditions, information for changing an imaging condition, etc.) together with the recorded images are displayed in the image display section 10 (menu display control section).

At this point, the user can execute (for example, setup change for imaging conditions) various setting changes (setup changes) by manipulating the key input section 9 according to the menu display in the image display section 10. The details of this setup change for imaging conditions will be described later.

Also, the CPU 9 judges whether or not there has been a change of setup for an imaging condition (discrimination section). This determination is judged by whether or not a manipulation signal command has been sent to perform a change of setup for an imaging condition from the key input section 15.

Then, whenever the setup for an imaging condition has been changed, the CPU 9 will be discriminated and will execute a setup change for an imaging condition according to an imaging condition changed by the user. Specifically, whenever a manipulation signal command is sent from the key input section 15 to perform a change of the setup for an imaging condition, the CPU 9 applies image processing to the video data imaged by the CCD 4 in order to establish this imaging condition setup change and then records in the flash memory 11 (recording control section).

Here, based on the video recording processing, the imaging condition of video data archived in the flash memory 11 becomes different relative to before and after a setup change of an imaging condition.

Besides, the CPU 9 judges whether or not a manipulation signal corresponding to the cancel key has been sent from the key input section 15 and, when sent, the menu display is terminated.

The CPU 9 performs the operation described above until a manipulation signal command (manipulation signal corresponding to a depression of the shutter button) has been sent to terminate the video recording from the key input section 15. Accordingly, the processing which archives the video data stored in the buffer area imaged by the CCD 4 to the flash memory 11 is discontinued.

C. Digital Camera 1 Operation

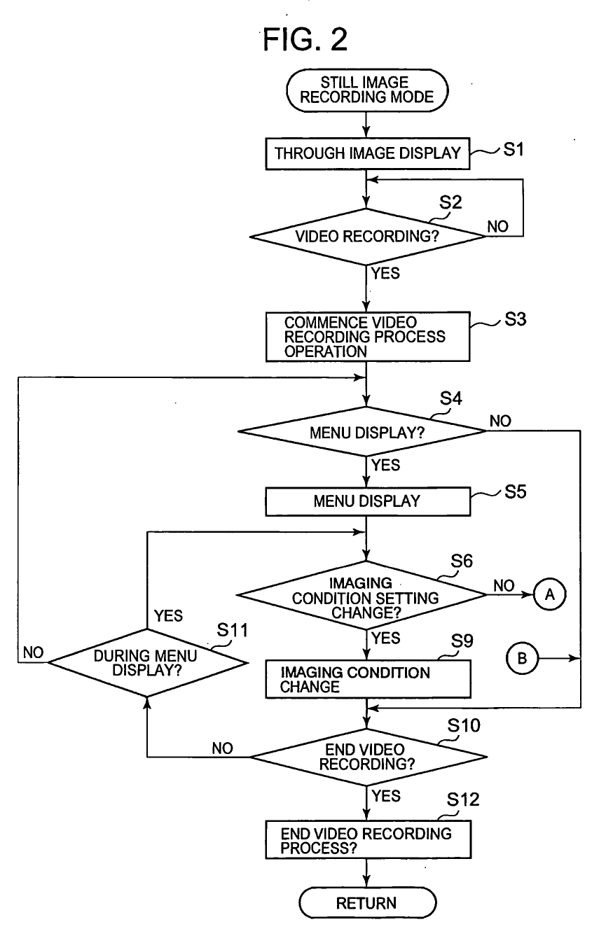

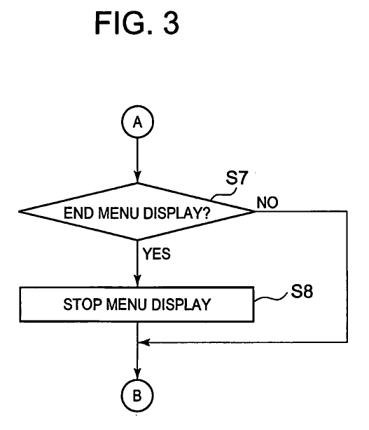

The operation of the digital camera 1 in the first preferred embodiment will be explained according to the flow chart of FIG. 2 and FIG. 3.

When set to the video recording mode by operation of a mode key from the user's key input section 15, at Step S1, the operation commences imaging to the CCD 4 and a through image of an imaged object will be displayed in the image display section 10. At this stage, as the image is displayed in the image display section 10, image processing is applied by the CPU 9 and the video data image being stored in the buffer memory is displayed.

Next, at Step S2, the CPU 9 judges whether or not a video recording is to be performed. This determination is judged by whether or not the CPU 9 received a manipulation signal corresponding to a depression of the shutter button from the key input section 15. Whenever the CPU 9 received a manipulation signal corresponding to a depression of the shutter button from the key input section 15, the operation judges that a video recording is to be performed.

At Step S2, when judged that a video recording is not to be performed, the operation will remain at Step S2 until determined that a video recording is to be performed. When judged that a video recording is to be performed, the operation will advance to Step S3 and video recording process commences.

With regard to the video recording process, the processing for archiving video data imaged by the CCD 4 is accomplished at a predetermined frame rate (fixed period of 1/30 second) in the flash memory 11. At this stage, the video data imaged by the CCD 4 undergoes image processing (pixel interpolation processing, etc.) and compression processing by the CPU 9 and then is recorded in the flash memory 11. Also, since images processed by the CCD 4 are displayed in the image display section 10, images archived by video recording process will be displayed in the image display section 10.

Next, the operation advances to Step S4 and judges whether or not a menu display is to be performed. This determination is judged by whether or not a manipulation signal has been sent to the CPU 9 corresponding to operation of the menu screen key of the user's key input section 15. Even if during a video recording, this menu display can be activated by the user in order to make a change to an imaging condition, etc.

At Step S4, when judged that the menu display is not to be performed, the operation will advance to Step S10. When judged that a menu display is to be performed, the operation advances to Step S5 and displays a menu as the photographed object image undergoing video recording processing in the image display section 10.

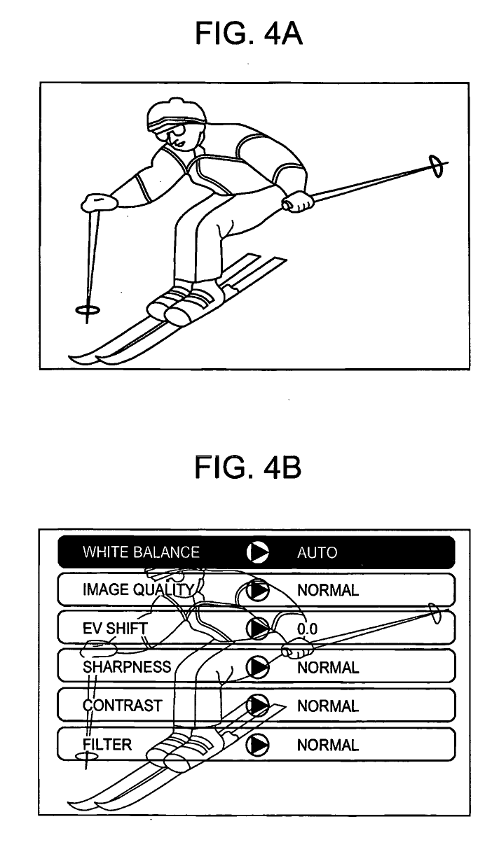

Here, directly before a menu display is performed, for example, an image as shown in FIG. 4A will be displayed. The image displayed in FIG. 4A is an image of an imaged object (person skiing) currently being processed as a video recording.

Also, when a menu display is performed, for example, an image as shown in FIG. 4B will be displayed. As seen in FIG. 4B, in the image display section 10, the menu (here, limited to the menu for changing an imaging condition of a video recording) is displayed in front (superimposed) of the photographed object image (person skiing) currently being recorded.

As for the contents of the menu display, for example, “WHITE BALANCE”, “IMAGE QUALITY”, “EV SHIFT”, etc. are shown. Currently, the setup shows the item fields for “WHITE BALANCE: AUTO”, “IMAGE QUALITY: NORMAL”, “EV SHIFT: 0.0”, “SHARPNESS: NORMAL”, “CONTRAST: NORMAL” and “FILTER: NORMAL”. Also, because the current video recording is ongoing, the menu being displayed is transparent so that the recording imaged object will not be hidden by the menu display.

Moreover, although currently the item field of the white balance is displayed in black, this represents a state where currently the white balance has been selected. Namely, the white balance is selected as the item field when the user wants to change an imaging condition.

Here, when a user manipulates “↓” of the cursor key of the key input section 15, the item selected will sequentially switch downwardly the “WHITE BALANCE”→“IMAGE QUALITY”→“EV SHIFT”→“SHARPNESS”. Also, when “↑” of the cursor key is manipulated, the item selected will switch in reverse sequence to “↓”.

In this manner, the user can select an item field to change an imaging condition by manipulating “↑” and “↓” of the cursor key.

Besides, in a state where the item field to change an imaging condition is selected, when the user manipulates “→” of the cursor key, the screen will switch to a state where the selected item field can be changed. For example, in a state where the white balance is selected, when the user manipulates “→” of the cursor key, this item field will switch to a state where the white balance can be changed.

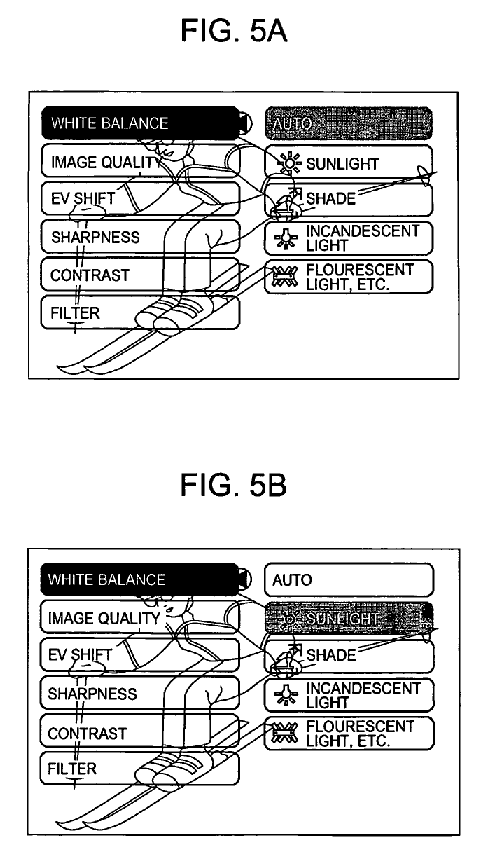

FIG. 5A shows the appearance of an image displayed in the image display section 10 when switching to a state where the white balance can be changed. On the right side of the item field for “WHITE BALANCE”, the item fields “AUTO”, “SUNLIGHT”, “SHADE”, “INCANDESCENT LIGHT”, “FLOURESCENT LIGHT”, etc. are displayed. “AUTO” adjusts the white balance in order that white is automatically reflected as white. When recording in sunlight, “SUNLIGHT” adjusts the white balance in order that white is reflected as white. When recording in the shade, “SHADE” adjusts the white balance in order that white is reflected as white. The same can be said of “INCANDESCENT LIGHT” and “FLOURESCENT LIGHT”.

Because currently the setup of the white balance is “AUTO”, the digital camera 1 is in a state where “AUTO” is selected (state where the item field of “AUTO” is black).

Here, when the user manipulates “I” of the cursor key of the key input section 15, the item field selected is sequentially switched, such as “AUTO”→“SUNLIGHT”→“SHADE”→“INCANDESCENT LIGHT”→“FLOURESCENT LIGHT”. At this time, whenever the white balance is changed (whenever changed in the item field selected), the recording image is displayed in the image display section 10 based on the imaging condition of the changed white balance. Accordingly, the user can set own preference of the white balance which can also be set as the user observes an image being displayed in the image display section 10. Here, the user has to be careful.•••• Although the white balance of the image being displayed in the image display section 10 changes whenever an imaging condition of the white balance changes, the white balance of recorded images archived in the flash memory 11 does not change. Also, the white balance for recording images archived in the flash memory 11 changes when the user ultimately decides to finalize a change of the setup for an imaging condition. Specifically, when the user manipulates the “↑”, “↓” of the cursor key in a state of selecting an imaging condition of a certain white balance and there has been a manipulation of the “SET” key.

Here, for example, since the current photography situation for recording is in sunlight, the user should select “SUNLIGHT” by manipulating the cursor key “↓”.

Then, when the user manipulates the “SET” key to a state where “SUNLIGHT” is selected, the setup of the white balance is changed (setup change) from “AUTO” to “SUNLIGHT”. Here, the first video data where image processing is applied based on this imaging condition setup change is archived in the flash memory 11. Specifically, although video data for “AUTO” white balance has been archived before a setup change (before manipulation of the “SET” key), video data for “SUNLIGHT” white balance will be archived after a setup change (after manipulation of the “SET” key) in the flash memory 11.

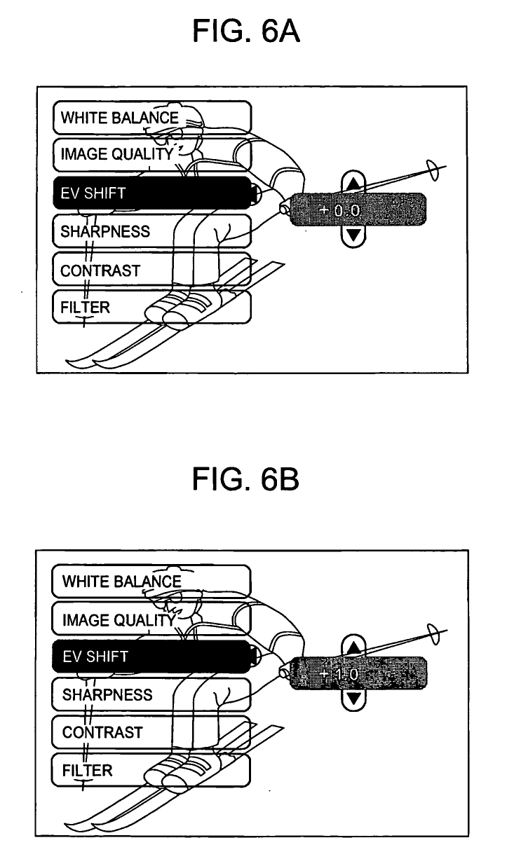

Additionally, in the state shown in FIG. 4B, when the user manipulates the “↓” of the cursor key to select “EV SHIFT” and the “→” of the cursor key is manipulated, the menu display switches to a state where EV (Exposure Value) can be changed as shown in FIG. 6A. Namely, the menu display switches to a state where exposure correction (also known as Exposure Compensation (EC)) can be changed.

As seen in FIG. 6A on the right side of the item field “EV SHIFT”, “±0.0” is displayed. The “±0.0” indicates that the current exposure correction setup is “±0.0”, namely, a state where exposure correction is not performed.

Also, the user's manipulation of the “↑” of the cursor key will display the exposure correction value as “±1.0” as seen in FIG. 6B. Subsequently, when the “↑” is manipulated, the exposure correction value increases (changes), such as “±2.0”→“±3.0.” Also, when the “↓” of the cursor key is manipulated, this value decreases contrary to “↑.” For example, when the current value is “±0.038 and the “↓” of the cursor key is manipulated, the exposure correction value decreases (changes), such as “±0.0”→“−1.0”→“−2.0.”

Even at this stage, as mentioned above, whenever the exposure correction value is changed, the recording image is displayed in the image display section 10 based on the changed exposure correction value. The exposure correction value of recorded images archived in the flash memory 11 does not change. For example, in the state shown in FIG. 6B where the exposure correction value has been changed to “±1.0” and when the user manipulates the “SET” key, a setup change of the exposure correction value is made from “±0.0” to “±1.0.” Here, the first video data where image processing is applied based on this imaging condition setup change is archived in the flash memory 11. Specifically, although video data for the exposure correction value of “±0.0” has been archived before a setup change (before manipulation of the “SET” key), video data for the exposure correction value “±1.0” will be archived after a setup change (after manipulation of the “SET” key) in the flash memory 11.

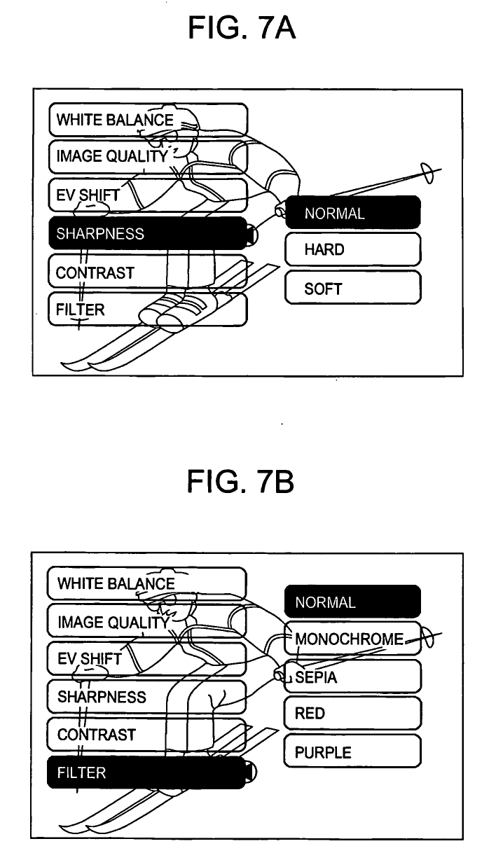

Additionally, in the state shown in FIG. 4B, when the user manipulates the “↓” of the cursor key to select “SHARPNESS” and the “→” of the cursor key is manipulated, the menu display switches to a state where the sharpness can be changed as shown in FIG. 7A. Here, a setup change for sharpness can be performed in three levels of “NORMAL”, “HARD” and “SOFT.”

Also, in the state shown in FIG. 4B, when the user manipulates the “↓” of the cursor key to select “FILTER” and the “→” of the cursor key is manipulated, the menu display switches to a state where the filter can be changed as shown in FIG. 7B. Here, a setup change for the filter can be performed in five varieties of “NORMAL”, “MONOCHROME”, “SEPIA”, “RED” and “PURPLE.” Image processing is applied with “MONOCHROME” so that a recording image has a monochrome undertone. Image processing is applied with “SEPIA” so that a recording image has a sepia undertone. Image processing is applied with “RED” so that a recording image has a red undertone. Image processing is applied with “PURPLE” so that a recording image has a purple undertone.

Additionally, in a state where the user can change an imaging condition, namely, when the “SET” key has been manipulated as shown in FIG. 5B and 6B, a setup change of an imaging condition is performed and an image as shown in FIG. 4B is displayed in the image display section 10.

Besides, in a state where the user can change an imaging condition, namely, when “←” of the cursor key is manipulated without manipulating the “SET” key in a state as shown in FIG. 5A, FIG. 5B, FIG. 6A, FIG. 6B, FIG. 7A and FIG. 7B, an image as shown in FIG. 4B is displayed in the image display section without performing a setup change of an imaging condition.

Also, when the user manipulates the cancel key in a state where an image as shown in FIG. 4B or FIG. 5A, FIG. 5B, FIG. 6A, FIG. 6B, FIG. 7A and FIG. 7B is displayed, only a photographed object image is displayed in the image display section as shown in FIG. 4A.

Furthermore, although uncommon that the appearance, size and posture of an imaged object (person skiing) as shown in FIGS. 4A-7B will be identical because this is a video recording, here the appearance, size and posture of the imaged object in FIGS. 4A-7B is, for convenience of explanation, is identical.

Now returning to the flow chart in FIG. 2, a menu display is performed at Step S5. The operation then advances to Step S6 and judges whether or not a setup change of an imaging condition has been performed. This determination is judged by whether or not the above-mentioned manipulation signal corresponding to manipulation of the “SET” key of the user's key input section 15 has been sent to the CPU 9. For example, as shown in FIG. 5B, when the “SET” key has been pressed in a state where the item field of “SUNLIGHT” for white balance has been selected, the CPU 9 judges that there has been a setup change of an imaging condition.

When the CPU 9 judges that a setup change of an imaging condition has not been performed at Step S6 (i.e., when a manipulation signal corresponding to manipulation of the “SET” key has not been sent to the CPU 9 from the key input section 15), the operation advances to Step S7 of FIG. 3 and judged whether or not the menu display has been terminated. As described above, this determination is judged by whether or not a manipulation signal corresponding to manipulation of the user's cancel key has been sent to the CPU 9.

When the CPU 9 judges that the menu display has been terminated at Step S7, the operation advances to Step S8 and display of the menu in the image display section 10 is discontinued and advances to Step S10 of FIG. 2. When judged that the menu display has not been terminated, the operation advances to Step S10 of FIG. 2 in that status.

On the other hand, when the CPU 9 judges at Step S6 an imaging condition has been changed, the operation advances to Step S9.•••• Then, after performing the setup change of an imaging condition, the operation advances to Step S10. Namely, video data archived in the flash memory 11 after a setup change is composed of video data to which image processing has been applied so as to become the imaging condition of the setup change. For example, when the item field of “SUNLIGHT” for white balance has been selected, video data to which image processing has been performed in order that white is automatically reflected as white in sunlight will be archived.

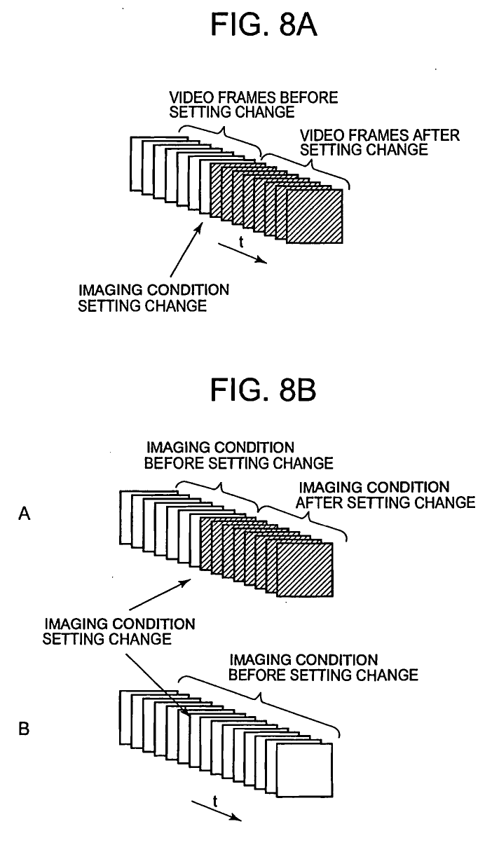

FIG. 8A shows the appearance of video data recorded in the flash memory 11 in an embodiment of the present invention and modified example three. As seen in this drawing, the video data is composed of a plurality of frames. Also, “t” expresses a time axis in the direction of the arrow. White frames indicate a recorded frame according to an imaging condition upon commencing a video recording process. Outlined frames with diagonal lines indicate a recorded frame according to an imaging condition setup change during a video recording process.

The other arrow in FIG. 8A shows the time point of an imaging condition setup change being performed. Also, FIG. 8A shows the video data recorded (archived) in the flash memory 11 will change based on imaging conditions before and after a setup change.

When the operation advances to Step S10, the CPU 9 judges whether or not video recording processing has been terminated. This determination is judged by whether or not a manipulation signal has been sent to the CPU 9 corresponding to a depression of the shutter button from the user's key input section 15. Here, the CPU 9 commences a video recording process when the shutter button is depressed one time. Moreover, when the shutter button is depressed once again, video recording processing is terminated. Besides, when the shutter button is depressed a video recording process commences and when the depression state of the shutter button is cancelled, the video recording archive (save) processing can be terminated. Also, when video data being archived reaches the storage capacity limit of the flash memory 11, the operation can also judge that the video recording archive processing must be terminated.

When the CPU 9 judges that a video recording has not been terminated at Step S10, the operation will advance to Step S11 and judge whether or not a menu display is to be performed. When a menu display is not to be performed, the operation reverts to Step S6. Conversely, when a menu display is to be performed, the operation reverts to Step S4 and the above-mentioned is repeated.

On the other hand, when the CPU 9 judges that a video recording has been terminated, the operation will advance to Step S12 and the video recording archive processing will be terminated. Namely, the processing which archives (saves) the image data processed by the CCD 4 and stored in the buffer memory (DRAM 7) is terminated.

Needless to say, video data archived in the flash memory 11 is only the video data imaged by the CCD 4 and image data (data related to the menu screen) of the menu displayed in the image display section 10 is not archived in the flash memory 11. In other words, only the video data of a recording image is archived in the flash memory 11 within the recording image displayed in the image display section 10 and the menu. Recording in flash memory of the data related to the menu screen is prohibited.

In the first preferred embodiment mentioned above, since a menu display can be performed even if during a video recording, the setup of an imaging condition, etc. can be easily changed as video recording progresses and maintained in a light weight and miniaturized digital camera 1. Further, since recording can be performed of video for one group of different imaging conditions, during playback, for example, the difference in effect for a before and after setup change of the white balance can be confirmed.

Also, in the above-mentioned preferred embodiment, although a menu for performing a setup change of an imaging condition for video recording is displayed, which makes it possible to perform a setup change of an imaging condition for video recording, it is possible to change the setup of various functions provided in the camera which are not an imaging condition for video recording. For example, a menu for performing a setup change of an imaging condition for still picture photography, a menu for performing a setup change of settings (such as a calendar, etc.), etc., which are completely unrelated photography settings.

### MODIFIED EXAMPLE ONE

The following modified example is also practicable for the above-mentioned preferred embodiment.

This is a modified example one in which a first mode and a second mode are comprised. The first mode may be set by manipulation of the mode key from the user's key input section 15 such as the above-mentioned preferred embodiment even if a menu display is performed during a video recording process and only the video data imaged by the CCD 4 is archived in the flash memory 11. Also, the second mode may be set by manipulation of the mode key from the user's key input section 15 made to archive not only the video data imaged by the CCD 4, but the image data (data related to the menu) of the menu displayed in the image display section 10.

Accordingly, in the second mode, the data of an image (the same menu image of when a photographed object image and the menu display are performed) displayed in the image display section 10 during video recording archive processing is saved in the flash memory 11 in that condition.

The video data imaged by the CCD 4 and the image data of the menu display are correlated and made to archive in the flash memory 11. Further, composite of the video data and the menu display image data can be made to archived as combined video data.

Accordingly, since a menu is also displayed with the recorded image data during playback of the video data, the steps required to perform an imaging condition change becomes easily recognizable. Furthermore, by being able to observe the current situation of an image before and after changing an imaging condition, the user can study exactly how an image will change when displayed and a setup for future imaging conditions can be anticipated. In this manner, appropriate imaging conditions can be set up corresponding to the photography situation, photograph intention, etc.

Additionally, when having a configuration which records composite video data and image data of the menu display in the second mode, by setting up the first mode so as to not record composite video data and image data of the menu display, the perceived annoyance of the user by the menu being displayed as video during video playback can be avoided. Also, when having a configuration which records correlated video data and image data of the menu display in the second mode, by setting up the first mode so to not record correlated video data and image data of the menu display, only the portion of the image data of the menu display is not recorded which reduces the volume of data. In this manner, the storage capacity of the flash memory 11 can be used efficiently.

Moreover, when video data and image data of the menu display are correlated and archived, the operation can be configured to make the user judge whether or not the correlated and archived image data of the menu display is also to be replayed during playback of video data.

Accordingly, in cases when not performing a menu display, since the menu is not displayed the perceived annoyance of the user by the menu being continuously displayed with the video during video playback can be avoided.

### MODIFIED EXAMPLE TWO

The following modified example is also practicable for the above-mentioned preferred embodiment.

In the recording processing of the above-mentioned preferred embodiment, video recording archive processing saves the video data imaged by the CCD 4 in the flash memory 11. Also, at that time, the video data archived in the flash memory 11 is video data imaged by the CCD 4 which undergoes image processing corresponding to a setup imaging condition (imaging condition setup change during a video recording). In the modified example two, intact video data imaged by the CCD 4, namely, unprocessed video data (video data, such as raw data, etc., which has neither undergone image processing nor compression processing) without image processing being applied corresponding to the setup imaging condition is archived in that condition. Also, the setup information of the imaging conditions relating to this stored video data is archived.

The setup information of the imaging conditions is data which represents recording according to the types of imaging conditions (white balance, exposure, etc.). When an imaging condition setup change is performed, the setup information of an imaging condition from that changed time point also becomes changed. Namely, when an imaging condition setup change is performed, the data setup change before and after a setup change will be archived.

Then, upon playback of the video data, image processing is applied to this archived video data according to this setting change information, and this applied video data is displayed in the image display section 10.

Accordingly, since video data is archived without applying any image processing corresponding to an imaging condition setup, even if the user's intentions change after recordings image processing (white balance, contrast, etc.) composed of a separate imaging condition can be performed. Also, since it is not necessary to perform image processing corresponding to an image condition setup during video recording archive processing, the load of the video recording archive processing can be reduced.

### MODIFIED EXAMPLE THREE

The following modified example is also practicable for the above-mentioned preferred embodiment.

In the above-mentioned preferred embodiment, when an imaging condition setup change is performed during video recording archive processing, image processing is applied according to the imaging condition after this setup change and then archived in the flash memory 11.

In the modified example three, even if it is a case where a setup change of an imaging condition is performed, the operation may also be configured to archive video data (source video data) to which image processing has been applied according to the imaging conditions at the time of commencing image recording archive processing.

Namely, in the modified example three the video data is archived in the flash memory 11 when a setup change is made during video recording archive processing and both the video data to which image processing has been applied according to an imaging condition after a change (the video data archived in the flash memory 11 by the above-mentioned preferred embodiment) and source video data (without applied image processing) will be archived.

Also, in the modified example three, although explained on the assumption that an imaging condition setup change is performed during video recording archive processing, when a setup change is not made during video recording archive processing, the number of the video data archived in the flash memory 11 is one file.

FIG. 8B shows the appearance of video data recorded in the flash memory 11 in the modified example three. As mentioned above, the white frames indicate a recorded frame according to an imaging condition upon commencing video recording processing. Outlined frames with diagonal lines indicate a recorded frame according to an imaging condition setup change during the video recording process.

As see in FIG. 8B, “A” indicates video data which has been archived in the flash memory 11 and in which a setup change was performed, and “B” indicates source video data archived in the flash memory 11.

The setup changed video data “A” typifies an imaging condition that changed from the time point that the imaging condition setup change has been performed. On the other hand, the source video data “B” typifies that even if an imaging condition setup change is performed, the imaging condition does not change and remains the imaging condition at the time a recording process commences.

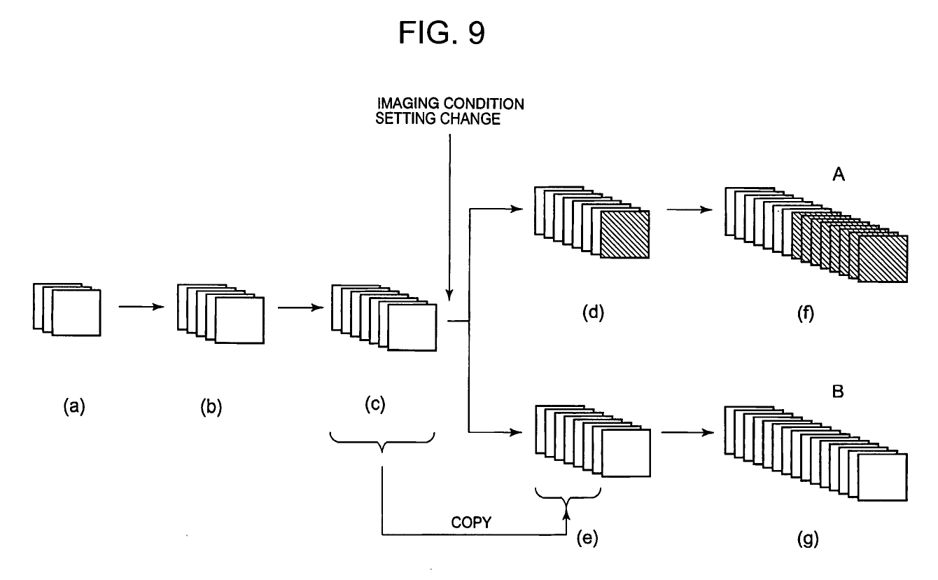

Next, an example of the recording process method of the source video data “B” and the video data “A” after a setup change will be explained according to the timing chart of FIG. 9.

Upon commencement of a video recording archive processing, each recorded frame is archived (saved), respectively. FIG. 9 (a), (b), (c) show the state roughly at this time. The number of frames currently archived increases as the time duration of the video recording elapses.

Then, at the time point of FIG. 9(c), an imaging condition setup change has been performed. As shown in FIG. 9(d), subsequent to the frames archived until then, the frame to which image processing has been applied according to an imaging condition setup change is then archived. Next, the succeeding frames according to this imaging condition setup change are also archived, respectively. By performing this processing, as shown in FIG. 9(f), the video data “A” in which a setup change has been performed will be archived in the flash memory 11.

Moreover, as shown in FIG. 9(e), when an imaging condition setup change is performed, a copy of all frames archived before an imaging condition setup change are archived in the flash memory 11. Subsequent to this archived copy of frames, the frame to which image processing according to the imaging conditions at the time image recording processing commenced is archived. Next, the succeeding frames to which image processing has been applied according to the imaging conditions at the time of image recording processing commenced are also archived, respectively. By performing this processing, as shown in FIG. 9(g), the source video data “B” will be archived in the flash memory 11.

Namely, when an imaging condition setup change is performed, the CPU 9 performs image processing according to the imaging conditions at the time of the recording process commencement and two image processes of image processing according to the imaging conditions after a setup change has been performed and two video data files will be archived in the flash memory 11.

Accordingly, even in cases of an imaging condition setup change failure, since the source video data “B” is archived, the failure of the imaging condition setup change can be collateralized. Also, the video which has not undergone an imaging condition setup change, since both the source video data “B” and the video data “A” after a setup change are archived, the effect of an imaging condition setup change, etc. can be confirmed by comparing the video which has undergone a setup change.

Besides, by being able to observe the changed condition of the image for the source video data “B” and the video data “A” after a setup change, the user can study exactly how an image will change when displayed and a setup for future imaging conditions can be anticipated. In this manner, an appropriate imaging condition can be set up corresponding to the photography situation, photograph intention, etc.

Moreover, during video playback in comparison with the modified example two, the encumbrance of video playback processing of only the portion which has not undergone image processing corresponding to the image conditions is mitigated.

Also, in the modified example three of the recording method of the source video data “B”, although the frames archived before an imaging condition setup change are copied and the frames to which image processing is applied according to the imaging conditions when the image recording process commences after those copied frames (refer to FIG. 9), the operation may be made not to copy the frames archived before an imaging condition setup change.

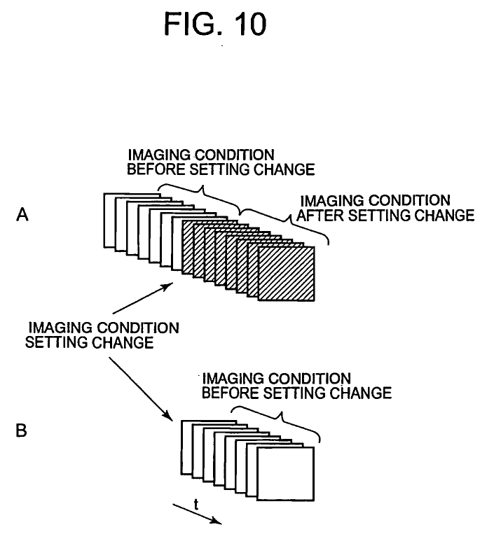

FIG. 10 shows the state of the video data “A” and the source data “B” after a setup change when recorded in the flash memory 11 of modified example three.

As seen in this diagram, the source video “B” is only video data imaged after an imaging condition setup change and image processing is applied according to the imaging conditions when the image recording process commences.

Also, the correlated video data “A” and the source video data “B” after a setup change are archived (saved) in the flash memory 11. The operation determines whether or not the user desires to display the video data “A” after a setup change during video playback or desires the source video data “B” to be displayed. When in the case of displaying the source video data “B”, the operation first replays the video data before a setup change of the video data “A.” Then, the video data “B” (video data after a setup change) is played back.

Accordingly, the wasteful archiving of the completely same video data can be excluded and the storage capacity of the flash memory 11 can be used efficiently.

Furthermore, in the modified example three, when an imaging condition setup change is performed in a video recording archive processing, the video data (video archived in the flash memory 11 by the above-mentioned preferred embodiment) and the source video data (video data to which image processing is applied according the imaging conditions when a video recording archive process commences) to which image processing according to the imaging conditions after this setup change has been applied is archived in the flash memory 11. However, with regard to whether or not an imaging condition setup change is performed during video recording archive processing, it is possible to make the operation archive both video data to which image processing has not been applied in the flash memory 11. In relation to video data to which this image processing is applied, in cases where an imaging condition setup change is performed in a video recording archive process, the video data (video data archived in the flash memory 11 by the above-mentioned preferred embodiment) to which image processing corresponding to this imaging condition according to the applied setup change will be archived.

Moreover, it is possible to combine modified example one and modified example two, as well as combine modified example one and modified example three.

In conclusion, the photography device in each of the above-mentioned preferred embodiments is not limited to the above-mentioned preferred embodiments. A digital camera, PDA, personal computer, digital video camera, etc. may be applicable. In other words, any type of equipment which can record video is effective.

While the present invention has been described with reference to the preferred embodiments, it is intended that the invention be not limited by any of the details of the description therein but includes all the embodiments which fall within the scope of the appended claims.

What is claimed is:

1. A photography device, comprising:
an image pickup section for imaging an imaged object and outputting video data;
a recording control section for recording video data outputted from said image pickup section to a recording section;
a menu display control section for displaying in a display section a menu screen to change setup of the photography device during a recording operation by said recording control section of video data to said recording section; and
a setup change section for changing setup of the photography device is changed by a user according to said menu screen displayed in said display section by said menu display control section.

2. The photography device according to claim 1, further comprising an image display control section for displaying in said display section video data outputted from said image pickup section during a recording operation by said recording control section of video data to said recording section.

3. The photography device according to claim 2, wherein said menu display control section displays in said display sections•• said menu screen simultaneously with video data displayed in said display section by said image display control section.

4. The photography device according to claim 3, wherein said menu display control section displays in said display section•• said menu screen in layers superimposed on video data displayed by said image display control section.

5. The photography device according to claim 2, wherein said recording control section records video data to said recording section from among video data displayed in said display section by said image display control section and said menu screen displayed in said display section by said menu display control section, and prohibits recording to said recording section of said menu screen.

6. The photography device according to claim 1, further comprising:
a selection section for selecting either a first mode or a second mode; and
said recording control section prohibits recording to said recording section data related to said menu screen displayed in said display section by said menu display control section when said first mode has been selected by said selection section.

7.••The photography device according to claim 6, wherein said recording control section records video data outputted from said image pickup section and data related to said menu screen displayed in said display section by said menu display control section to said recording section when said second mode has been selected by said selection section.

8. The photography device according to claim 7, wherein said recording control section records correlated video data outputted from said image pickup section and data related to said menu screen to said recording section when said second mode has been selected by said selection section.

9. The photography device according to claim 7, wherein said recording control section records a composite of video data outputted from said image pickup section and image data of said menu screen as combined video data to said recording section when said second mode has been selected by said selection section.

10. The photography device according to claim 1, further comprising:
a menu display instruction section for instructing display in said display section of said menu screen; and
said menu display control section displays in said display section said menu screen when instructed to display said menu screen by said menu display instruction section.

11. The photography device according to claim 1, wherein said menu screen is for changing setup of the photography device and for changing setup of video recording; and
wherein setup for a video recording is changed by a user with said setup change section according to said menu screen displayed in said display section by said menu display control section.

12. The photography device according to claim 11, wherein said recording control section records video data to said recording section based on changed setup, when setup for a video recording has been changed by said setup change section.

13. The photography device according to claim 12, further comprising an image processing section for applying image processing to video data outputted from said image pickup section;
said image processing section applies image processing based on changed setup to video data outputted from said image pickup section after setup changes, when setup for a video recording has been changed by said setup change section; and
said recording control section records video data with applied image processing by said image processing section to said recording section.

14. The photography device according to claim 13, wherein said recording section records both video data with applied image processing by said image processing section and video data without applied image processing by said image processing section to said recording section.

15. The photography device according to claim 13, further comprising a discrimination section for discriminating whether or not setup has been changed by said setup change section;
said image processing section applies image processing based on changed setup and image processing based on setup before being changed, respectively, to video data outputted from said image pickup section after setup changes, when discriminated setup has been changed by said discrimination section; and
said recording control section records both image data with applied image processing based on changed setup and video data with applied image processing based on setup before being changed to said recording section.

16. The photography device according to claim 11, wherein said recording control section records video data that does not reflect setup changed by said setup change section and setup change information changed by said setup change section to said recording section.

17. A photography device, comprising:
an image pickup section for imaging an imaged object and outputting video data;
a setup section for setup an imaging condition for video recording by a user;
a recording control section for recording video data outputted from said image pickup section to a recording section; and
said recording control section records setup information based on an imaging condition for video recording set by said setup section to said recording section, while recording video data outputted from said image pickup section.

18. A photography device, comprising:
an image pickup section for imaging an imaged object and outputting video data;
a setup section for setup of an imaging condition for video recording by a user;
a recording control section for recording video data outputted from said image pickup section to a recording section; and
said recording control section records video data that does not reflect an imaging condition for video recording set by said setup section to said recording section, while recording video data that does reflect an imaging condition for video recording set by said setup section to said recording section.

19. A photography device, comprising:
an image pickup section for imaging an imaged object and outputting video data;
a recording control section for recording video data outputted from said image pickup section to a recording section;
a setup section for setup of an imaging condition for video recording by a user regardless of whether or not while recording video data to said recording section by said recording control section; and
said recording control section records video data outputted from said image pickup section to said recording section at least based on current imaging condition for video recording set by said setup section.

20. A photography method for a photography device, comprising the steps of:
imaging an imaged object and outputting video data;
recording video data on a recording medium;
displaying in a display section a menu screen to change setup of the photography device during a recording operation by said step for recording of video data to said recording medium; and
changing setup of the photography device by a user according to said menu screen displayed in said display section.

21. A program documentation medium for storing a recording control program executed by a processor in a photography device, comprising the steps of:
imaging an imaged object and outputting video data;
recording video data on a recording medium;
displaying in a display section a menu screen to change setup of the photography device during a recording operation by said step for recording of video data to said recording medium; and
changing setup of the photography device by a user according to said menu screen displayed on said display section.
